(19) United States
(12) Patent Application Publication
(10) Pub. No.: US 2023/0020063 A1
(43) Pub. Date: Jan. 19, 2023

(54) SENSOR, AND CORIOLIS METER

(71) Applicant: Endress+Hauser Flowtec AG, Reinach (CH)

(72) Inventors: Martin Josef Anklin, Dornach (CH); Reinhard Huber, Bad Säckingen (DE); Benjamin Schwenter, Ettingen (CH); Sandro Schwab, Oftringen (CH)

(21) Appl. No.: 17/757,465

(22) PCT Filed: Nov. 20, 2020
(86) PCT No.: PCT/EP2020/082930

§ 371 Date: Jun. 16, 2022

(30) Foreign Application Priority Data
Dec. 16, 2019 (DE) 10 2019 134 600.2

(51) Int. Cl. G01K 13/02; G01F 1/84; G01K 1/143

(52) U.S. Cl. CPC G01K 13/02; G01F 1/8413; G01F 1/8472; G01K 1/143

(57) ABSTRACT

The invention relates to a sensor of a Coriolis meter for measuring the mass flow or the density of a medium flowing through a pipe, said sensor comprising: at least one measuring tube for conducting the medium, each having an inlet and an outlet; at least one exciter for exciting measuring tube oscillations; at least two sensors for detecting measuring tube oscillations; a support body for holding the measuring tube. The sensor has an RFID temperature sensor which is designed to determine a temperature of the measuring tube, the sensor having an RF transceiver which is designed to read out the temperature sensor.

The invention relates to a measurement sensor of a Coriolis measuring device and to such a Coriolis measuring device.

Coriolis measuring devices are designed to determine a mass flow and a density of a medium flowing through a pipe. The medium is conducted through at least one Coriolis measuring device measuring tube, which is excited to oscillate by means of an exciter. Sensors read out these oscillations and, for example, on the basis of excitation power and oscillation amplitude and a phase shift between excitation and measuring tube oscillation, values listed above can be determined.

However, the measuring tube oscillations are not only dependent on the medium and the excitation, but also on a measuring tube temperature, which, for example, influences a surface moment of area of the measuring tube and thus measuring tube oscillations. In the prior art, temperature sensors are therefore used in order to be able to incorporate the influence of the measuring tube temperature on measuring tube oscillations.

However, the use of temperature sensors results in an increased cabling effort, which increases the probability of a partial failure of the Coriolis measuring device due to cable breakage and makes manufacture and assembly more cumbersome.

The object of the invention is to provide a measurement sensor with temperature sensor and a Coriolis measuring device having such a measurement sensor, in which a failure probability is reduced and assembly and manufacture is less complicated.

The object is achieved by a measurement sensor according to independent claim 1 and by a Coriolis measuring device according to independent claim 10.

A measurement sensor according to the invention of a Coriolis measuring device for measuring the mass flow or the density of a medium flowing through a pipe comprises:

at least one measuring tube for conducting the medium, each having an inlet and an outlet;

at least one exciter for exciting measuring tube oscillations;

at least two sensors for detecting measuring tube oscillations;

a support body for holding the measuring tube;

wherein the measurement sensor has an RFID temperature sensor, which is designed to determine a temperature of the measuring tube,

wherein the measurement sensor has an RF transceiver which is designed to read out the temperature sensor.

The RFID temperature sensor is a passive sensor and draws its energy from a radio frequency signal generated by the RF transceiver.

In one embodiment, the temperature sensor is attached to the measuring tube.

In this way, the temperature can be measured precisely, with the disadvantage that measuring tube oscillations are influenced slightly.

In one embodiment, the at least one measuring tube has at least one fixing plate on an inlet side of the measuring tube and one on an outlet side of the measuring tube, wherein the at least one fixing plate of a respective side is designed to fix the measuring tube and to define an oscillation node,

wherein the temperature sensor is attached to the measuring tube or a fixing plate.

Mounting the temperature sensor on the fixing plate slightly reduces precision of the temperature measurement, but allows free oscillation of the measuring tube.

In one embodiment, the transceiver is designed to read out the temperature sensor continuously or at intervals of less than 10 seconds.

In this way, the mass flow or the density of the medium can be tracked with sufficient time resolution.

In one embodiment, the at least one measuring tube is exchangeable with the temperature sensor, wherein the measurement sensor has a coupling for coupling and decoupling at least one measuring tube.

Especially in the case of a measurement sensor having an exchangeable measuring tube, simplified handling during assembly is of great advantage. Especially in technical fields in which there are increased hygiene requirements, measuring tubes of measurement sensors must be replaced, for example when mediums are changed, in order to avoid contamination of the mediums with one another. For example, when there is filling with various active ingredients of medications, it is absolutely necessary for these active substances to remain spatially separated. Measurement sensors having a measuring tube that can be replaced by means of a coupling are also referred to as “disposable,” because, in contrast to normal measurement sensors, the at least one measuring tube can be greatly simplified and replaced relatively quickly by means of the coupling. The coupling can have a latching mechanism, for example.

In one embodiment, the temperature sensor can be sterilized by gamma radiation without impairing its functionality. In the case of “disposable” measuring devices, a sterilization of the measuring tubes by gamma radiation takes place before the measuring tubes are used. Ideally, the temperature sensor is sterilized with the measuring tube in order to avoid contamination of the measuring tube by subsequent application of the temperature sensor.

Such gamma-sterilizable temperature sensors are sold, inter alia, by Verigenics under the name GammaTag.

In one embodiment, the temperature sensor is designed to transmit further information, for example device data such as nominal width of the measuring tube, calibration factor of the measuring tube, zero point of the Coriolis measuring system, device number and/or density coefficients of the measuring tube. The zero point thus corresponds to an oscillation frequency, for example at zero flow or without a medium. Density coefficients are required for calculating a density of a medium from other variables, such as oscillation frequency and/or temperature of the measuring tube, for example.

In one embodiment, the transceiver and the temperature sensor are at least partially surrounded by a shield, which shield is designed to reduce a load on the exciter and the sensors due to electromagnetic radiation emitted by the transceiver.

In one embodiment, the transceiver is thermally decoupled from the measuring tube.

In this way, for example, an asymmetry between the inlet and the outlet with regard to oscillation properties due to unequal temperature distribution can be avoided.

A Coriolis measuring device according to the invention comprises a measurement sensor according to the invention and an electronic measuring/operating circuit for operating the measurement sensor and for providing and outputting flow or density measurements.

The invention will now be described with reference to exemplary embodiments.

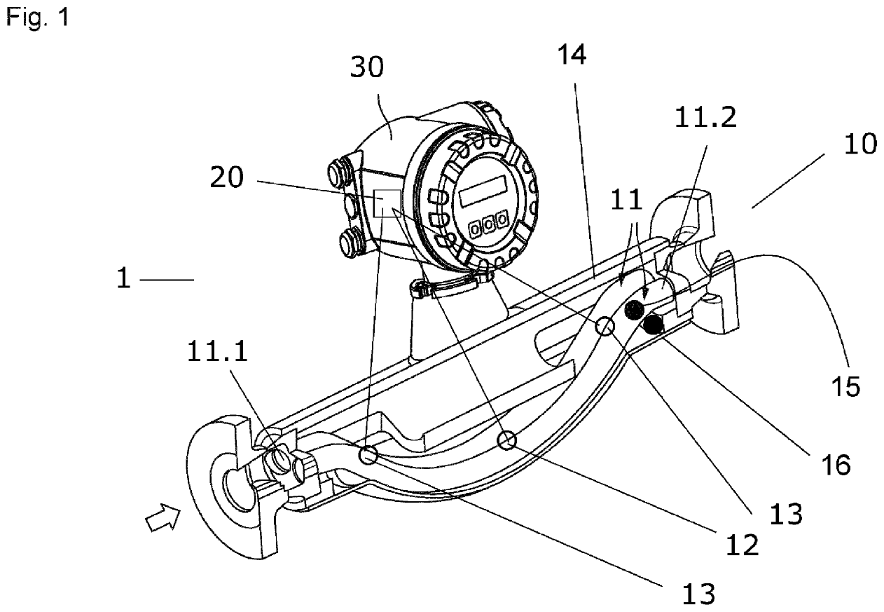

FIG. 1 illustrates an exemplary Coriolis flow measuring device according to the invention;

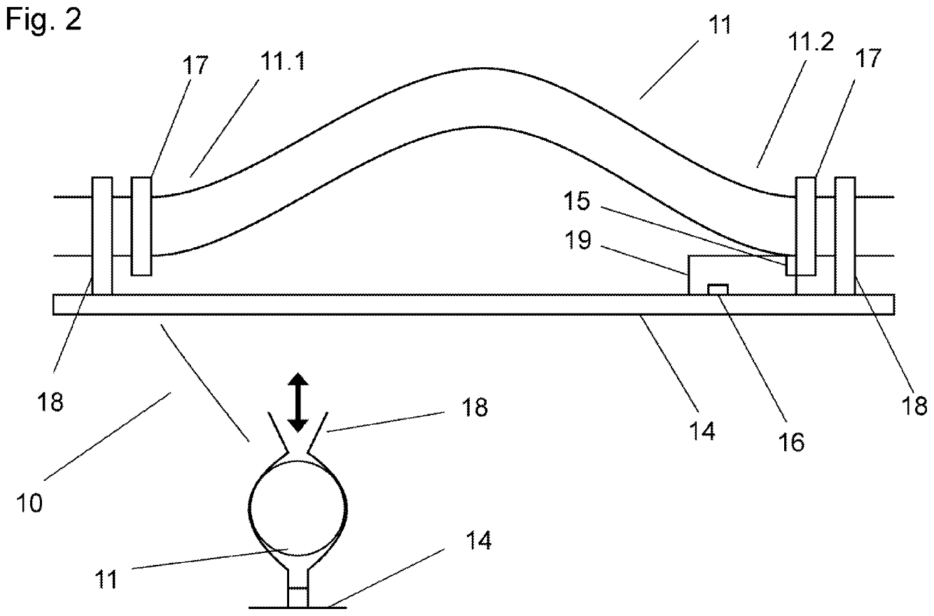

FIG. 2 illustrates a side view of an exemplary measurement sensor according to the invention;

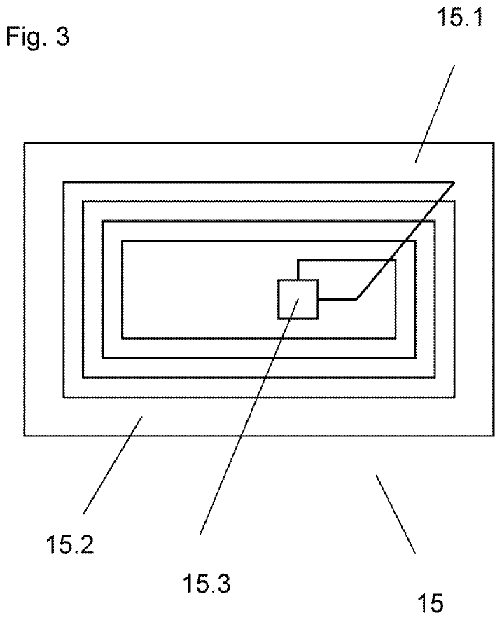

FIG. 3 illustrates an exemplary RFID temperature sensor according to the invention.

FIG. 1 shows a Coriolis measuring device 1 with a measurement sensor 10, an electronic measuring/operating circuit 20 and a housing 30 for housing the electronic measuring/operating circuit.

The measurement sensor has two measuring tubes 11, each having an inlet 11.1 and an outlet 11.2, which are held by a support body 14. The measuring tubes are designed to oscillate relative to one another. The measuring tube number shown here is an example; the measurement sensor can also have, for example, only one measuring tube or four measuring tubes which are arranged especially in two measuring tube pairs, wherein the measuring tubes of a pair are designed to oscillate relative to one another. The measurement sensor has an exciter 12, which is designed to excite oscillation of the measuring tubes. The measurement sensor has two sensors 13, which are designed to detect the measuring tube oscillations. A medium flowing through the measuring tubes influences the measuring tube vibrations in a characteristic manner, so that a mass flow and/or a density of the medium and/or a viscosity of the medium can be derived from the measurement signals of the sensors. The oscillation properties of the measuring tube are also influenced by a measuring tube temperature, so that a temperature sensor 15 is provided in order to detect the measuring tube temperature. In order to avoid further cabling, the temperature sensor is designed according to the invention as an RFID temperature sensor 15, which, as indicated here, can be attached to a measuring tube. An RFID transceiver 16 is designed to read out the temperature sensor 15. The readout preferably takes place quasi-continuously or at intervals of less than 10 seconds.

FIG. 2 shows a schematic side view of an exemplary measurement sensor 10 according to the invention having a measuring tube 11, which measuring tube is held on by a support body 14. As shown here, the mechanical connection can be a connection which is releasable without great effort and which is produced by means of a coupling 18. In technical fields with increased hygiene requirements, measuring tubes of measurement sensors must be replaced, for example when mediums are changed, in order to avoid contamination of the mediums with one another. For example, when there is filling with various active ingredients of medications, it is absolutely necessary for these active substances to remain spatially separated. Measurement sensors having a measuring tube that can be replaced by means of a coupling are also referred to as “disposable,” because, in contrast to normal measurement sensors, the at least one measuring tube can be greatly simplified and replaced relatively quickly by means of the coupling. The coupling can have, for example, a latching mechanism with two arms, as indicated in the illustrated front view. By pulling or pressing the measuring tube in the direction indicated by the double arrow, the measuring tube can latch into the coupling or be pulled out of the coupling. In this case, the arms have a geometric shape which, when the measuring tube is pressed into a desired position and when the measuring tube is removed, leads to an opening movement of the arms. The coupling shown here is to be interpreted purely by way of example and not as limiting. As shown here, the at least one measuring tube can have at the inlet 11.1 and at the outlet 11.2 in each case at least one fixing plate 17, which is/are designed to define oscillations nodes of the measuring tube oscillations. In contrast to what is indicated in FIG. 1, the temperature sensor 15 can also be fastened, as shown here, to a fixing plate. This prevents any influence by measuring tube oscillations. Because the fixing plates are in good thermal contact with the measuring tube, a measuring tube temperature determination is only slightly impaired. The transceiver 16 can, as shown here, be arranged on the support body in spatial proximity to the temperature sensor. Among other things, a thermal decoupling of the transceiver from the measuring tube can be designed in this way. The spatial proximity enables the RFID temperature sensor to be read out with low radiation power. Thus, a disturbance of electromagnetically sensitive objects such as sensors or exciters, for example, is reduced. For the purpose of further reducing these disturbances, a shield 19 can be designed, as shown here, which defines a spatial volume in which the RFID radiation can preferably expand. However, depending on the design of sensors and exciters as well as temperature sensor and transceiver, a shielding may also be unnecessary. This is especially the case if there is sufficient separation of electronic operating frequencies.

In one embodiment, the temperature sensor can be sterilized by gamma radiation without impairing its functionality. In the case of “disposable” measuring devices, a sterilization of the measuring tubes by gamma radiation takes place before the measuring tubes are used. Ideally, the temperature sensor is sterilized together with the measuring tube in order to avoid contamination of the measuring tube by subsequent application of the temperature sensor.

In one embodiment, the temperature sensor is designed to transmit further information, for example device data, such as nominal width, calibration factor, zero point, device number and/or density coefficients. In this way, data required for correct operation of the Coriolis measuring device can be retrieved after insertion of a new measuring tube or new measuring tubes into a measurement sensor.

The measuring tube number shown here is an example; the measurement sensor can also have, for example, two measuring tubes or four measuring tubes which are arranged especially in measuring tube pairs, wherein the measuring tubes of a pair are designed to oscillate relative to one another.

FIG. 3 illustrates the structure of an exemplary RFID temperature sensor comprising a microchip 15.3, a coil 15.2 and a sensor substrate 15.1, on which sensor substrate 15.1 coil and microchip are applied. The coil is designed to detect radio frequency signals generated by the RF transceiver and to convert them into an electrical voltage, as well as to output radio frequency response signals in response to such radio frequency signals. The microchip is operated by the electrical voltage generated by means of the coil, and is, therefore, a passive component. For this purpose, the microchip has two contacts, by means of which it is electrically connected to one end of the coil in each case. A connection with a remote coil end extends over windings of the coil, and is electrically insulated from these windings. The microchip has a temperature measuring function. The microchip can also be designed to output further information such as, for example, device data such as nominal width, calibration factor, zero point, device number and/or density coefficients. The substrate and the coil can be designed flexibly, so that the temperature sensor can also be applied to curved surfaces. Such a microchip is manufactured, for example, by Fujitsu and sold under the name Fujitsu MB89R118.

### LIST OF REFERENCE SIGNS

1 Coriolis measuring device
10 Measurement sensor
11 Measuring tube
11.1 Inlet
11.2 Outlet
12 Exciter
13 Sensor element
14 Support body
15 RFID temperature sensor
15.1 Sensor substrate
15.2 Coil
15.3 Microchip
16 RF transceiver
17 Fixing plate
18 Coupling
19 Shield
20 Electronic measuring/operating circuit
30 Housing

1-10. (canceled)

11. A measurement sensor of a Coriolis measuring device for measuring the mass flow or the density of a medium flowing through a pipe, comprising:
at least one measuring tube for conducting the medium, each having an inlet and an outlet;
at least one exciter for exciting measuring tube oscillations;
at least two sensors for detecting measuring tube oscillations; and
a support body for holding the measuring tube;
wherein the measurement sensor has an RFID temperature sensor which is designed to determine a temperature of the measuring tube;
wherein the measurement sensor has an RF transceiver which is designed to read out the temperature sensor.

12. The measurement sensor according to claim 1,
wherein the temperature sensor is attached to the measuring tube.

13. The measurement sensor according to claim 1,
wherein the at least one measuring tube has at least one fixing plate on an inlet side of the measuring tube and at least one fixing plate on an outlet side of the measuring tube, wherein the at least one fixing plate of a respective side is designed to fix the measuring tube and to define an oscillation node,
wherein the temperature sensor is attached to the measuring tube or a fixing plate.

14. The measurement sensor according to claim 1,
wherein the transceiver is designed to read out the temperature sensor continuously or at intervals of less than 10 seconds.

15. The measurement sensor according to claim 1,
wherein the at least one measuring tube and the temperature sensor are replaceable,
wherein the measurement sensor has a coupling for coupling and decoupling at least one of the measuring tubes.

16. The measurement sensor according to claim 15,
wherein the temperature sensor can be sterilized by gamma radiation without impairing its functionality.

17. The measurement sensor according to claim 1,
wherein the temperature sensor is designed to transmit further information.

18. The measurement sensor according to claim 1,
wherein the transceiver and the temperature sensor are at least partially surrounded by a shield,
wherein the shield is designed to reduce a load on the exciter and the sensors due to electromagnetic radiation emitted by the transceiver.

19. The measurement sensor according to claim 1, wherein the transceiver is thermally decoupled from the measuring tube.

20. A Coriolis measuring device, comprising:
a measurement sensor according to claim 1,
an electronic measuring/operating circuit for operating the measurement sensor and for providing and outputting flow or density measurements,
a housing for housing the electronic measuring/operating circuit.
